(19) United States
(12) Patent Application Publication
(10) Pub. No.: US 2003/0185091 A1
(43) Pub. Date: Oct. 2, 2003

(54) Linear motor and electric injection molding machine using the same

(75) Inventors: Jun Koike, Shizuoka-ken (JP); Hiroyuki Onuma, Mishima-shi (JP); Katsuhito Ogura, Numazu-shi (JP); Harumichi Tokuyama, Odawara-shi (JP); Katsuyoshi Kido, Numazu-shi (JP); Hajime Kitamura, Fuji-shi (JP)

Correspondence Address: PILLSBURY WINTHROP, LLP, P.O. BOX 10500, MCLEAN, VA, 22102, US

(73) Assignee: TOSHIBA MACHINE CO., LTD., Tokyo (JP)

(21) Appl. No.: 10/400,456

(22) Filed: Mar. 28, 2003

(30) Foreign Application Priority Data
Mar. 29, 2002 (JP) 2002-097523
Mar. 3, 2003 (JP) 2003-056065

(51) Int. Cl. B29C 45/50; B29C 45/58; B29B 7/14

(52) U.S. Cl. 366/92; 366/78; 425/208; 366/79

(57) ABSTRACT

An electric injection molding machine comprises a barrel which holds a screw therein, a voice coil type linear motor which moves the screw in the axial direction thereof. The linear motor has a coil, a yoke extending along the coil, and a magnet movable relatively to the coil in the axial direction thereof. The injection molding machine comprises a coolant passage in the yoke and a cooling device for cooling the coil. Temperature related to the coil or a coolant is detected, and the coolant is control in accordance with the detected temperature.

### CROSS-REFERENCE TO RELATED APPLICATIONS

This application is based upon and claims the benefit of priority from the prior Japanese Patent Applications No. 2002-097523, filed Mar. 29, 2002; and No. 2003-056065, filed Mar. 3, 2003, the entire contents of both of which are incorporated herein by reference.

### BACKGROUND OF THE INVENTION

1. Field of the Invention

The present invention relates to a linear motor and an electric injection molding machine using the same.

2. Description of the Related Art

A linear motor may possibly be used as a drive source for the injection operation of an electric injection molding machine. A synchronous linear motor 1 shown in FIG. 10, for example, comprises a coil assembly 3, a guide member 4 that extends along the assembly 3, and a movable element 6 including a magnet 5 that moves linearly along the guide member 4. The coil assembly 3 is a planar structure designed so that a large number of independent coils 3a are arranged at given pitches in the direction indicated by arrow A.

The movable element 6 of the linear motor 1 can make linear motion in the direction of arrow A, based on a magnetic field that is generated as the coils 3a are supplied with current. Thus, a screw of the injection molding machine can be moved in its axial direction with the movable element 6 coupled to its basal part so that the linear motion of the movable element 6 can be transmitted to the screw.

Electric injection molding machines that use a conventional linear motor, such as the synchronous linear motor 1, as their drive source may be affected by heat from coils, depending on the working conditions.

Each coil of the conventional synchronous linear motor requires use of inlet and outlet pipes for a coolant, and it is hard to secure a sufficient area of contact between each coil and the coolant. Thus, the coils are liable to be heated.

If the use of the injection molding machine is continued with the coils heated intensely, the coils may possibly snap or suffer failure in insulation. If the coils are heated, moreover, the thrust of the linear motor may possibly lower, or the magnet may be demagnetized.

In some cases, furthermore, precision measuring devices, such as linear scales for position measurement, may be located near the linear motor. Therefore, these precision devices may be affected by heat. With use of the injection molding machine that has the conventional linear motor as its drive source, it is hard to prevent trouble that is attributable to heating of the coils.

### BRIEF SUMMARY OF THE INVENTION

Accordingly, the object of the present invention is to provide a linear motor capable of preventing troubles that may be caused by heat from coils and an electric injection molding machine using the linear motor.

A voice coil type linear motor of the present invention comprises a cylindrical coil for magnetic field generation, a yoke extending along the coil, a magnet movable relatively to the coil in the axial direction thereof, and cooling means which cools the coil. As the cooling means, a liquid or gas coolant is run through a coolant passage that is formed in, for example, the yoke, whereby the yoke and the coil are cooled. This configuration can prevent trouble that is attributable to overheating.

The voice coil type linear motor stated herein is a linear motor that comprises a cylindrical coil formed of a winding wound in the shape of a cylinder, a yoke (iron core) disposed inside or outside the coil so as to extend in the axial direction of the coil, and a magnet movable relatively to the coil in its axial direction by means of a magnetic field the coil generates. Although the magnet stated herein is a permanent magnet, in general, it may alternatively be an electromagnet.

An electric injection molding machine according to the invention comprises a barrel which holds a screw therein and a voice coil type linear motor for moving the screw in the axial direction. The linear motor is provided with cooling means for cooling the coil. This configuration can prevent trouble that may otherwise be caused by heat from the linear motor.

Preferably, the electric injection molding machine of the invention comprises a temperature sensor, which detects temperature related to the coil or a coolant of the cooling means, and a control device which controls the coolant in accordance with the temperature detected by the temperature sensor. This configuration can control the coolant according to the heating condition of the coil and further effectively prevent overheating of the coil or the like.

The magnet may be provided with a cooling jacket through which the coolant circulates so that the magnet can be also cooled. According to this configuration, the magnet can be also cooled, so that the magnet can be prevented from being influenced by heat from the coil.

The cooling means may be an electronic cooling device having Peltier elements and radiator fins. If the electronic cooling device having Peltier elements and radiator fins is used as the cooling means, the temperature of the linear motor can be controlled electrically, so that the temperature control is easy. When compared with the case where a fluid is used as the coolant, moreover, the cooling device can be made more compact.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of an electric injection molding machine according to a first embodiment of the invention;

FIG. 2 is a sectional view of a part of the injection molding machine of FIG. 1 taken in its axial direction;

FIG. 3 is a sectional view typically showing an advanced state of a screw of the injection molding machine of FIG. 1;

FIG. 4 is a perspective view typically showing a part of a voice coil type linear motor;

FIG. 5 is a sectional view showing the voice coil type linear motor and a cooling device of the injection molding machine of FIG. 1;

FIG. 6 is a sectional view of a yoke of the voice coil type linear motor shown in FIG. 5;

FIG. 7 is a sectional view taken along line F7-F7 of FIG. 6;

FIG. 8 is a sectional view showing a linear motor and a cooling device of an electric injection molding machine according to a second embodiment of the invention;

FIG. 9 is a sectional view showing a linear motor and an electronic cooling device of an electric injection molding machine according to a third embodiment of the invention; and

FIG. 10 is a perspective view of a conventional synchronous linear motor.

### DETAILED DESCRIPTION OF THE INVENTION

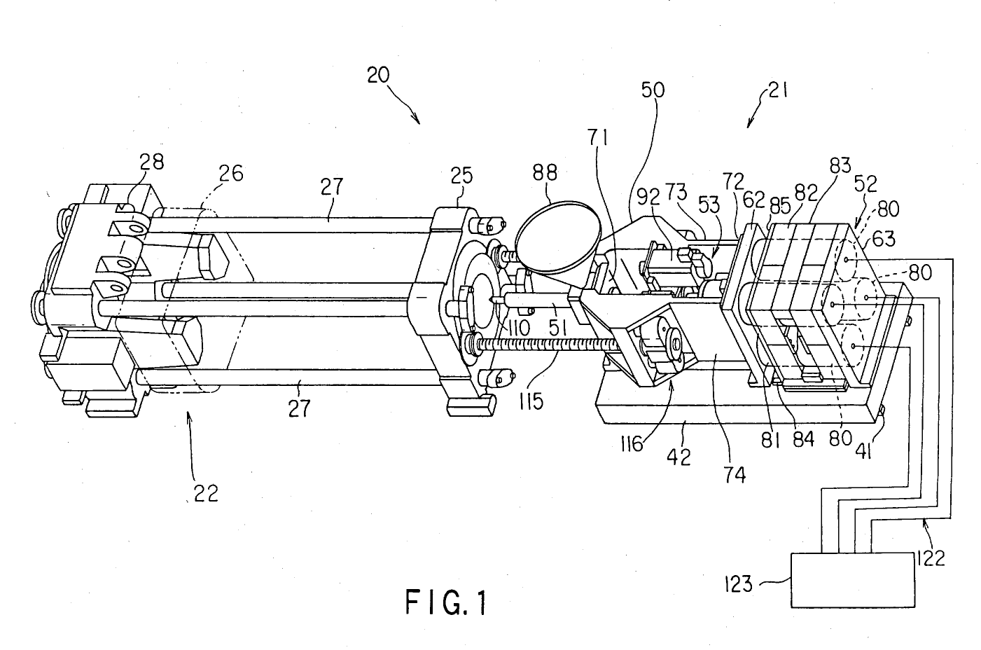

A first embodiment of the present invention will now be described with reference to FIGS. 1 to 7.

An electric injection molding machine 20 shown in FIG. 1 comprises an injection unit 21 situated on the right-hand side of FIG. 1 and a die clamping unit 22 on the left-hand side.

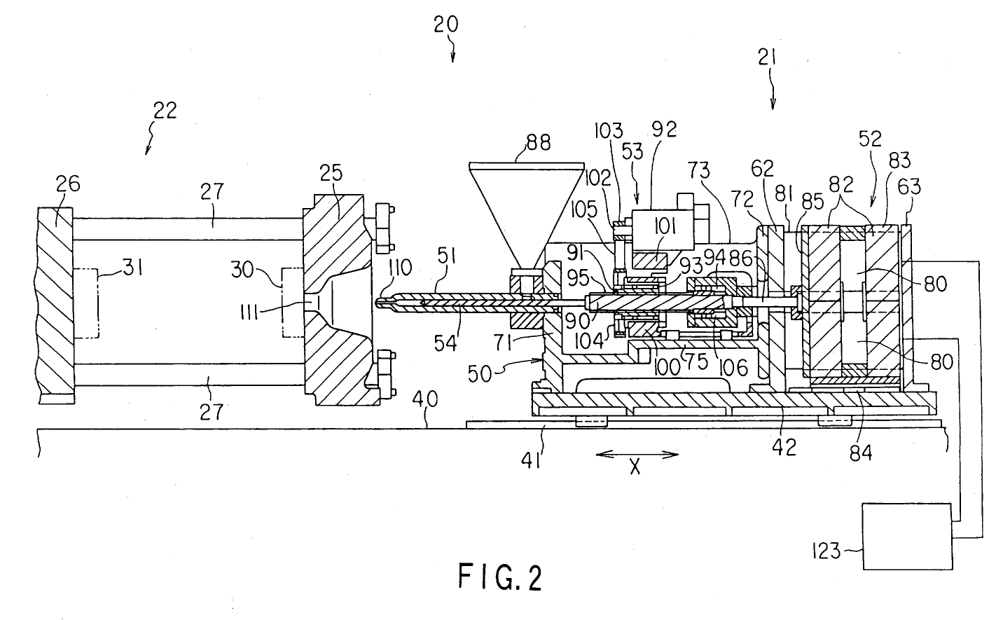

The die clamping unit 22 comprises a stationary platen 25, a movable platen 26, a drive mechanism 28 (only a part of which is shown) for moving the movable platen 26 along a tie-bar 27, and the like. A stationary die 30 (shown in FIG. 2) is attached to the stationary platen 25. A movable die 31 is attached to the movable platen 26.

As shown in FIG. 2, the injection unit 21 is provided on a stationary base 40. The injection unit 21 has a slide base 42 that can reciprocate along a guide rail 41 on the stationary base 40. The injection unit 21 can move in the longitudinal direction of the injection molding machine 20 (or in the axial direction indicated by arrow X in FIG. 2).

The injection unit 21 includes a frame structure 50, a barrel 51, a voice coil type linear motor 52 that functions as a drive source for injection operation, a screw rotating mechanism 53, etc. The barrel 51 holds a screw 54 therein. The linear motor 52 will be described in detail later.

The frame structure 50, a front stand 62, and a rear stand 63 are fixed on the slide base 42.

The frame structure 50 has a first portion 71 that supports the basal part of the barrel 51, a second portion 72 coupled to the linear motor 52, and left- and right-hand connecting walls 73 and 74 that connects the respective opposite side portions of the first and second portions 71 and 72, a bottom wall 75, etc. The first and second portions 71 and 72, connecting walls 73 and 74, and bottom wall 75 are molded integrally with one another by casting. The frame structure 50 is in the form of a bottomed box as a whole.

The voice coil type linear motor 52 is provided with a stationary member 81 and a movable member 83. The stationary member 81 includes a plurality of electromagnetic coils 80 that are arranged parallel to one another between the stands 62 and 63. The movable member 83 includes a permanent magnet 82 that are driven in the X-direction by means of a magnetic field the coils 80 generate.

The movable member 83 of the linear motor 52 can reciprocate between the stands 62 and 63 along a guide member 84 on the slide base 42. An output shaft 86 is connected to a connecting plate 85, a part of the movable member 83.

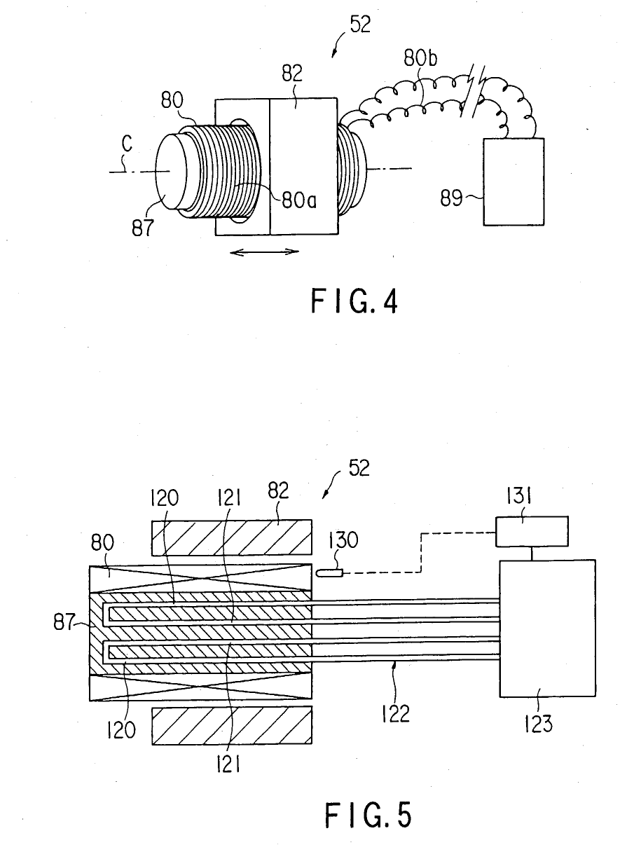

As is typically shown in FIG. 4, each coil 80 of the voice coil type linear motor 52 is formed by winding a conducting wire 80a into a hollow cylinder. An iron core (yoke 87) is disposed inside the coil 80. The magnet 82 is fitted on the outer periphery of the coil 80. The movable member 83 that includes the magnet 82 relatively moves in the direction of an axis C of the coil 80, based on a magnetic field that is generated as the coil 80 is supplied with current.

The coil 80 is connected to a current supplier 89 by means of power cables 80b. In order to prevent snapping of the cables 80b, it is advisable to set the coil 80 and the magnet 82 on the stationary side and on the movable side, respectively, as in this embodiment. In order to allow the power cables 80b to move naturally, however, the coil 80 and the yoke 87 may be set on the movable side, and the magnet 82 on the stationary side.

Alternatively, moreover, a magnet and a yoke may be located in- and outside the coil 80, respectively. The coil 80 may be in the shape of a square tube. The magnet 82 may also be of any desired suitable shape. The linear motor 52 is a direct current type linear motor.

A hopper 88 for supplying a resin, a material of injection-molded pieces, is provided near the basal part of the barrel 51. The hopper 88 is mounted on a first portion 71 of the frame structure 50. A heater (not shown) for heating and melting the resin is attached to the barrel 51.

The screw rotating mechanism 53 includes a shaft 90 to which the screw 54 is connected, a sleeve member 91 fitted on the shaft 90, a motor 92 for rotating the sleeve member 91, first and second bearing portions 93 and 94, etc.

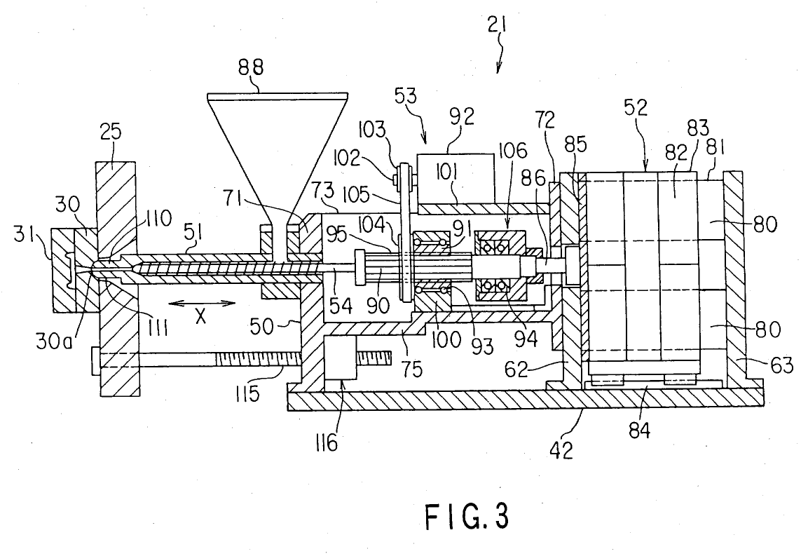

More specifically, a spline portion 95 is formed on the outer peripheral portion of the shaft 90 so as to extend along its axis, as is typically shown in FIG. 3. The sleeve member 91 is fitted on the spline portion 95. Thus, the shaft 90 can move relatively to the spline portion 95 in the axial direction. Also, the shaft 90 and the sleeve member 91 can rotate integrally with each other.

The sleeve member 91 is rotatably supported on an intermediate supporting wall 100 by means of the first bearing portion 93. The wall 100 is fixed to the bottom wall 75 of the frame structure 50.

A motor supporting portion 101 is located on the upper part of the frame structure 50. The motor 92 is set on the supporting portion 101. A power transmission member 105, such as a belt, is passed around and between a driving pulley 103 and a driven pulley 104. The driving pulley 103 is mounted on an output shaft 102 of the motor 92. The driven pulley 104 is mounted on the sleeve member 91. Thus, the sleeve member 91 can be rotated by rotating the output shaft 102 of the motor 92. When the sleeve member 91 rotates, the shaft 90 that is fitted in the spline portion 95 rotates, so that the screw 54 rotates.

The rear end portion of the shaft 90 is connected to the output shaft 86 of the linear motor 52 by means of a coupling mechanism 106 that is provided with the second bearing portion 94. The coupling mechanism 106 connects the output shaft 86 and the shaft 90 to each other and allows their relative rotation. Thus, an axial linear motion of the output shaft 86 can be transmitted to the shaft 90. However, the rotation of the shaft 90 cannot be transmitted to the output shaft 86.

A nozzle 110 that is formed on the distal end portion of the barrel 51 is situated on the center line of a hole 111 in the stationary platen 25. The stationary platen 25 and the frame structure 50 are connected to each other by means of, for example, a ball screw 115 and a nozzle touch mechanism 116 that uses a servomotor or the like.

By driving the nozzle touch mechanism 116, the injection unit 21 can be advanced and retreated along the guide rail 41 with respect to the stationary platen 25. When the injection unit 21 is in its predetermined advanced position, the distal end of the nozzle 110 engages an injection port 30a of the stationary die 30.

As shown in FIGS. 5 to 7, the voice coil type linear motor 52 has coolant passages 120 and 121 that are formed in the yoke 87 and serve as cooling means for the coil 80. Heat that is generated from the coil 80 acts on the outer peripheral side of the yoke 87. In order to enhance the cooling efficiency, therefore, the coolant passage 120 on the inlet side is formed on the outer peripheral side of the yoke 87, and the coolant passage 121 on the return side is formed near the center of the yoke 87.

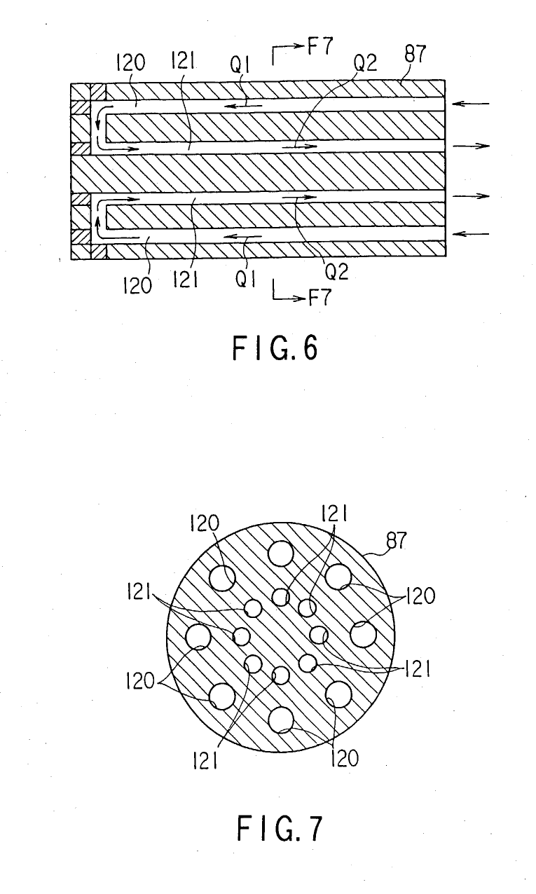

The coolant passages 120 and 121 are connected to a cooling device 123 by means of a coolant pipe 122. The coolant passages 120 and 121, coolant pipe 122, cooling device 123, etc. constitute cooling means according to the present invention. A gas or gas-liquid mixture, as well as a liquid, may be used as a coolant. The inlet-side coolant passage 120 shown in FIG. 7 has a flow area wider than that of the return-side coolant passage 121. However, the passages 120 and 121 may have the same flow area.

As shown in FIG. 5, a temperature sensor 130 is provided for detecting the temperature of the coil 80. A signal related to the temperature detected by the sensor 130 is delivered to a control device 131. The control device 131 controls the cooling device 123 to keep the temperature of the coolant within a predetermined range. More specifically, the temperature near the coil 80 is measured by means of the temperature sensor 130 to control the cooling device 123. The temperature of the coil 80 may be estimated by detecting the temperature of the coolant instead of detecting the temperature near the coil 80.

Inside the yoke 87, the coolant flows in the directions indicated by arrows Q1 and Q2 as is shown in FIG. 6. The temperature of the coolant is controlled by means of the cooling device 123, and the temperature-controlled coolant flows through the coolant passages 120 and 121. The coolant can positively cool the coil 80, thereby keeping the coil 80 and its surroundings at substantially fixed temperatures.

Anything abnormal about the injection molding machine 20 can be detected by means of a sensor for monitoring the temperature of the coolant. If any abnormality is detected, an alarm may be given to the control system of the machine 20, or the operation of the machine 20 may be stopped.

The following is a description of the operation of the injection molding machine 20 constructed in this manner.

The dies 30 and 31 are closed by means of the die clamping unit 22. The distal end of the nozzle 110 is caused to engage the injection port 30a of the stationary die 30 by advancing the injection unit 21 toward the stationary platen 25 by means of the nozzle touch mechanism 116.

As is typically shown in FIG. 3, the movable member 83 of the linear motor 52 is advanced by supplying current to the coil 80 of the motor 52. When the movable member 83 is advanced, the shaft 90 is advanced by means of the output shaft 86. As the screw 54 advances, moreover, the previously changed molten resin in the barrel 51 is pushed out through the distal end of the nozzle 110 by means of the screw 54, and loaded into the dies 30 and 31.

After the resin that is injected into the dies 30 and 31 is cooled, the screw 54 is retreated for a given distance by retreating the movable member 83 of the linear motor 52. Further, the screw 54 is rotated by rotating the shaft 90 by means of the motor 92. When the screw 54 rotates, the molten resin is fed toward the distal end of the barrel 51 as it is kneaded and charged. Then, the dies 30 and 31 are opened, and a molded product is pushed out by means of an ejector mechanism. Thereupon, one cycle of an injection molding process terminates.

The frame structure 50 of this injection molding machine 20 is an integrally molded piece (e.g., casting) in the shape of a box. Thus, it naturally has a great resistance to longitudinal tensile load, and can exhibit substantial stiffness in the vertical and horizontal directions. If the linear motor 52 drives the screw 54 for high-speed linear motion, therefore, the frame structure 50 can be restrained from being vibrated or deformed.

The motor 92 for screw rotation is fixed to the motor supporting portion 101 on the stiff frame structure 50. The sleeve member 91 is fitted on the shaft 90 with the aid of the spline portion 95. According to this construction, the motor 92 stays on the motor supporting portion 101 without making any linear motion when the linear motor 52 drives the screw 54 for axial linear motion. Thus, a movable-side mass (inertia mass) that makes linear motion integrally with the screw 54 can be lessened, so that linear reciprocation by the linear motor 52 can be speeded up.

For these reasons, the necessary cycle time for injection molding can be shortened. Since the frame structure 50 is integrally molded by casting, moreover, the number of its indispensable parts can be reduced.

In the voice coil type linear motor 52 of this embodiment, the temperature of the coolant that flows inside the coil 80 is controlled by means of the cooling device 123. Since the coil 80 is cooled as the temperature-controlled coolant flows through the coolant passages 120 and 121, the coil 80 and its surroundings can be kept at substantially fixed desired temperatures. Thus, snapping of the coil 80 or lowering of thrust that is attributable to overheating, demagnetization of the magnet 82, or other trouble can be prevented.

Further, the temperature of the ambience of the coil 80 can be restrained from increasing by checking the rise of the temperature of the coil 80. In consequence, various apparatuses that are arranged near the coil 80 can avoid being influenced by high temperature.

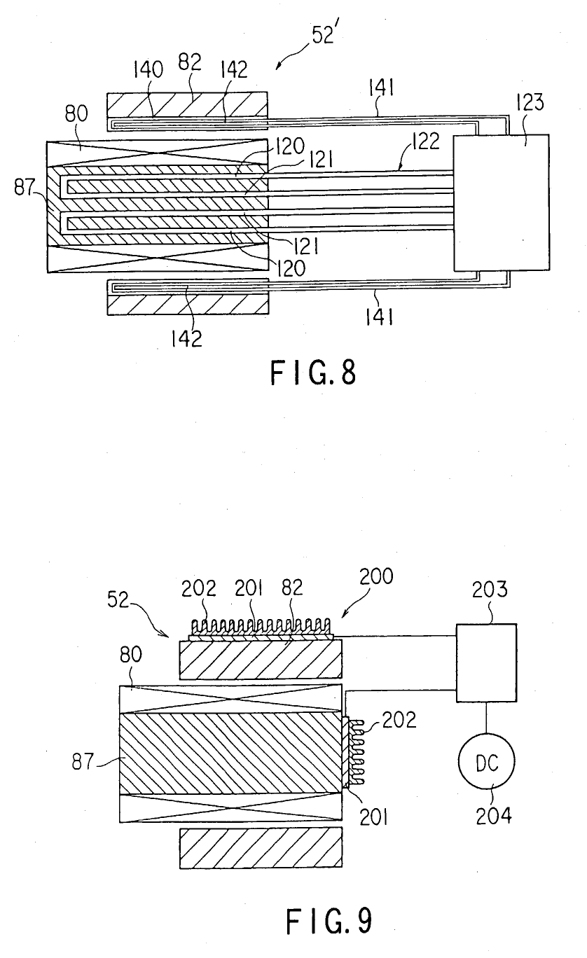

FIG. 8 shows a voice coil type linear motor 52′ of an injection molding machine according to a second embodiment of the invention. The linear motor 52′ has a cooling jacket 140 on the inner surface of a magnet 82. Thus, the magnet 82 that is influenced by heat from a coil 80 can be also cooled.

A coolant pipe 141 is connected to the cooling jacket 140. The magnet 82 is positively cooled as the coolant that is cooled by means of a cooling device 123 flows through a coolant passage 142 of the cooling jacket 140. The second embodiment shares other configurations and functions with the injection unit 21 of the first embodiment, so that common numerals are used to designate common portions of the two embodiments, and a description of those portions is omitted.

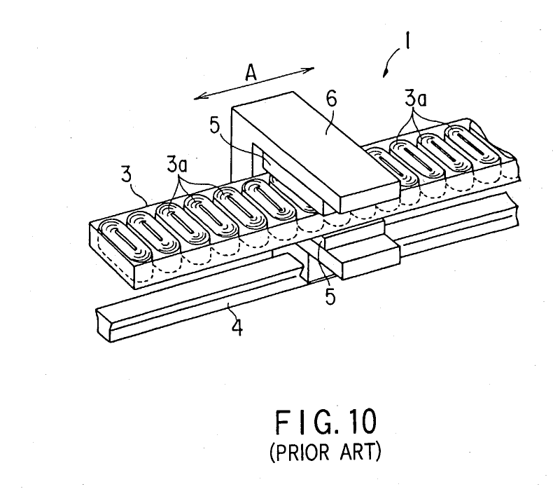

FIG. 9 shows a voice coil type linear motor 52 of an injection molding machine according to a third embodiment of the invention. This linear motor 52 comprises an electronic cooling device 200. The device 200 includes Peltier elements 201 which shows Peltier effect, radiator fins 202 for cooling the elements 201, a controller 203 for controlling direct current that is supplied to the element 201, etc.

A low-temperature surface of each Peltier element 201 is attached to a magnet 82 and a yoke 87. The radiator fins 202 are provided on a high-temperature surface of each element 201. If current from a DC power source 204 is supplied to the Peltier elements 201, the magnet 82 and the yoke 87 are cooled by the agency of the Peltier effect. The temperature of the voice coil type linear motor 52 can be controlled by controlling the current by means of the controller 203. The third embodiment shares other configurations and functions with the injection unit 21 of the first embodiment, so that common numerals are used to designate common portions of the two embodiments, and a description of those portions is omitted.

It is to be understood, in carrying out the present invention, that the components of the invention, including the voice coil type linear motor and the like, may be suitably changed or modified without departing from the scope or spirit of the invention. The invention is also applicable to injection molding machines for plastic or metallic products.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A voice coil type linear motor comprising:
a cylindrical coil for magnetic field generation;
a yoke extending along the coil;
a magnet movable relatively to the coil in the axial direction thereof; and
cooling means which cools the coil.

2. An electric injection molding machine comprising:
a barrel which holds a screw therein; and
a drive section having a linear motor for use as a drive source which moves the screw in the axial direction thereof;
the linear motor being a voice coil type linear motor comprising a cylindrical coil for magnetic field generation, a yoke extending along the coil, a magnet movable relatively to the coil in the axial direction thereof, and cooling means which cools the coil.

3. An electric injection molding machine according to claim 2, further comprising a temperature sensor, which detects temperature related to the coil or a coolant of the cooling means, and a control device which controls the coolant in accordance with the temperature detected by the temperature sensor.

4. An electric injection molding machine according to claim 2, wherein the magnet is provided with a cooling jacket through which the coolant circulates.

5. An electric injection molding machine according to claim 3, wherein the magnet is provided with a cooling jacket through which the coolant circulates.

6. A voice coil type linear motor according to claim 1, wherein the cooling means is an electronic cooling device having Peltier elements.

7. An electric injection molding machine according to claim 2, wherein the cooling means is an electronic cooling device having Peltier elements.
